(19) United States
(12) Patent Application Publication
(10) Pub. No.: US 2022/0221369 A1
(43) Pub. Date: Jul. 14, 2022

(54) A METHOD FOR SURVEYING A STRUCTURE AND A PROCESS FOR DEFINING AN OPTIMUM METHOD OF SURVEYING SAID STRUCTURE

(71) Applicant: SACERTIS S.R.L., Roma (IT)

(72) Inventor: Simona MANCINI, TORINO (IT)

(73) Assignee: SACERTIS S.R.L., Roma (IT)

(21) Appl. No.: 17/609,892

(22) PCT Filed: May 11, 2020
(86) PCT No.: PCT/IB2020/054433

§ 371 Date: Nov. 9, 2021

(30) Foreign Application Priority Data
May 10, 2019 (IT) 102019000006735

(51) Int. Cl. G01M 5/00

(52) U.S. Cl. CPC G01M 5/0041

(57) ABSTRACT

Method for surveying a structure (1) comprising: a) defining specific parameters of the structure (1) by discretizing it into a plurality of elements and discretizing in turn each element into nodes, b) defining specific parameters for each node including the rotations in the nodes, c) defining a number of usable sensors, d) imposing specific constraints as a function of the effective number of sensors and the mutual distances thereof, e) using an exact algorithm of the branch and bound or genetic or neural type or combinations thereof in order to calculate a solution (Si) which identifies a second plurality of (N) nodes at which to position at least one sensor and which maximizes the total of the rotations read, f) positioning the sensors (3) on the structure (1) in accordance with the solution (Si) which is produced by the step e).

### TECHNICAL FIELD

The invention relates to a method for surveying a structure and a process for defining an optimum method of surveying the structure itself.

### TECHNOLOGICAL BACKGROUND

Within the analysis of structures such as, for example, bridges, viaducts, buildings, etc., it is routine to install sensors which allow monitoring of the state of deformation and/or tension of the structure being examined or portions thereof. Normally, this operation is carried out by entrusting it to the competences of a person skilled in the art who identifies what, in his/her opinion, may be the control parameters which are most sensitive and significant for the specific structure being examined and decides arbitrarily which types of sensors to use and where to position them.

It is evident that this methodology becomes more effective with the increasing competence and knowledge of the consultant consulted. On the other hand, however, there is the risk that, if the competence of the consultant is insufficient for a correct evaluation of the structure being analyzed, the sensors used are positioned in a sub-optimal manner, thereby providing information which is incomplete and potentially ineffective.

Furthermore, these sensors could be positioned so as to take only some significant kinematic mechanisms according to some specific load scenarios which are present in the structure while making it impossible to record other phenomena which are potentially important in the evaluation of any anomalies in terms of the behaviour of the structure being examined.

It is clear that this method, when it is applied according to the indications of the consultant consulted, corresponds to a method solved by means of an explicit enumeration and for this reason may be carried out only on a limited number of variables, with the drawback of it being impossible to obtain an optimum solution (that is to say, a maximization of a specific objective function within the shortest possible times). In this sense, an evident discrimination between the method discussed present in the prior art is the one set out according to the present invention and the requirement for time and computational resources necessary in order to arrive at a maximization of the objective function.

Therefore, it is clearly evident that this method carried out according to the teachings of the prior art places the consultant in the difficult position of having to critically evaluate his/her own competences in order to attempt to establish, on the one hand, whether the monitoring project with the positioning of the sensors on the structure at predetermined positions can be effectively effective and, on the other hand, whether the method based on explicit enumeration takes into consideration and correctly analyzes at least the parameters and the potentially most critical situations in relation to the safety of the structure under investigation.

### Statement of Invention

An object of the present invention is to provide a method of surveying a structure and a process which are functionally configured to at least partially overcome at least one of the disadvantages of the prior art.

Within this object, an objective is to provide a method or process which allows the structure being examined to be provided with instruments and controlled in an optimum manner, ensuring an effective monitoring thereof over time and maintaining the cost of this activity at an economically advantageous and competitive level.

Furthermore, still within this object, another objective is to develop a method and a process for surveying the structure which can be applied in an objective and reproducible manner in order to reduce the possible discretional contributions which are formulated subjectively by the consultant employed.

This object is achieved by the method and process carried out according to claims 1 to 8. Preferred features of the invention are defined in the dependent claims.

### DESCRIPTION OF THE DRAWINGS

The features and advantages of the invention will be better appreciated from the following detailed description of a number of preferred embodiments thereof which are illustrated by way of non-limiting example with reference to the appended drawings, in which:

FIG. 1 illustrates a model FEM of a structural element which is being surveyed and to which a method and a process according to the present invention are applied,

FIG. 2 illustrates the rotations calculated in each node of the FEM model, as in FIG. 1, for some load scenarios applied to the structural element being surveyed of FIG. 1,

FIG. 3 illustrates an example of a discretized structure comprising the structural element of FIG. 1.

### DETAILED DESCRIPTION OF A PREFERRED EMBODIMENT

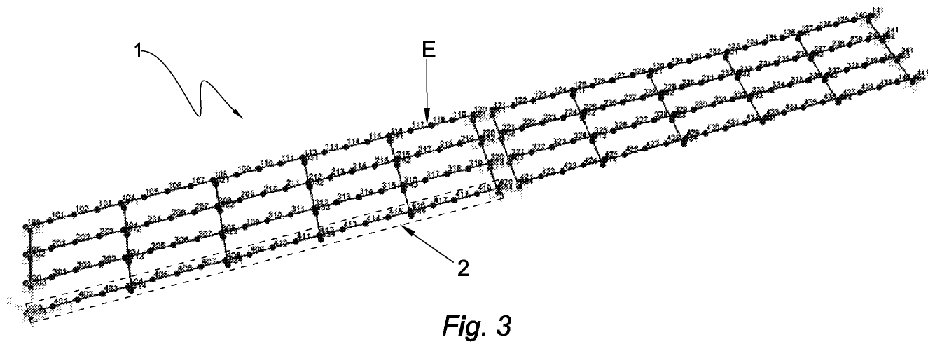

FIG. 3 illustrates a structure which is being surveyed and to which the method and/or the process as described by the present invention are applied.

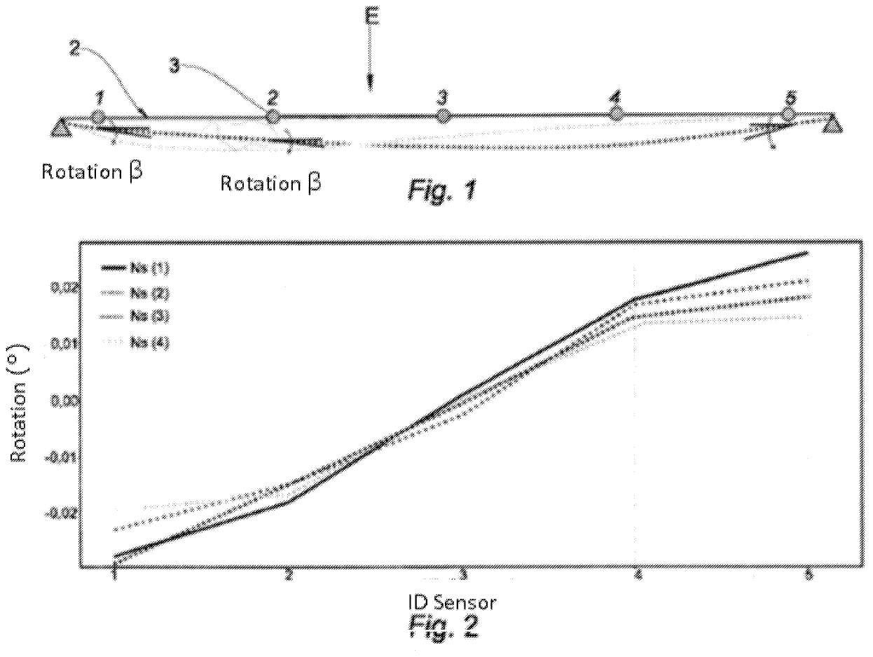

Preferably, the developed method for surveying the structure 1 provides for
a) defining the following parameters of the structure 1,
   a first plurality of elements 2 which constitute the structure 1, in which each element E of the first plurality of elements is discretized into a local plurality of corresponding nodes, bidimensional and/or tridimensional elements (see FIGS. 1 and 3 by way of reference),
   a minimum number of sensors Eminₜ for each element which have to be localized in accordance with the type of the element,
   a number of nodes M in which at least one sensor can be positioned,
   a potential i-th position Ni, having respective coordinates xi, yi, zi, of the relevant corresponding node on which it is possible to position a sensor 3, the i-th index i being a integer between 1 and M,
   a potential j-th position Nj, having respective coordinates xj, yj, zj, of the relevant corresponding node on which it is possible to position a sensor 3, the j-th index j being a integer between 1 and M and different from the value of the i-th index i,
   a matrix of the distances dij as a function of each potential i-th position Ni and of the potential j-th position Nj between the possible nodes M,
   a set S of the load scenarios which are applicable to the structure being examined and a corresponding number of the load scenarios Ns,
   a rotation value Cis for a potential i-th position node Ni which has as a subscript the i-th index i and an s-th index s between 1 and the number of load scenarios Ns.

It is thereby possible to define the key parameters of the structure by imposing spatial relationships between the potential i-th positions and j-th positions Ni, Nj, the minimum number of sensors Eminₜ necessary for each element of the structure, the total number of nodes M present in the structure, the matrix of the distances dij, the set of load scenarios Ns and the rotation values Cis.

By way of non-limiting example, FIG. 1 illustrates an example of an element 2 (contained in a modelled single-strand structure (for example, beams) FEM of an element E of the beam type) which is discretized with seven nodes (two of which are constraint nodes, five of which are the potential positions for the location of the sensors and the six “beam” type elements). Similarly, and still by way of example, FIG. 3 illustrates a structure 1 comprising sixteen elements (eight longitudinal beams and eight transverse beams).

In other words, there is carried out a first step of discretizing the structure into structural elements and then, for each structural element, a second discretization into nodes which relates to the specific structural element under consideration.

FIG. 2 further illustrates possible load scenarios (for example, four different load scenarios).

These illustrations serve only to assist and better understand the field of use of the present invention, taking into account that the application of the above-mentioned method or process is always preferable by means of implicit enumeration.

Preferably, the following equations and constraints apply:

d_{i,j}=|Nⱼ−Nᵢ|, i, j ϵ1={1, . . . , M}, with i≠j distance between each pair of nodes i and j dₘᵢₙ, dₘₐₓ=minimum distance and maximum distance between two consecutive positions of sensors;

$$N \geq {E}_{min}$$

$${d}_{min} \leq {d}_{i , j} \leq {d}_{max}$$

Furthermore, the above-mentioned method advantageously provides for:
b) defining for each node
   a type or class of element to which it belongs (for example, beam, cross-member, etc.),
   a specific element of the class E (for example, beam 1, beam 2),
   a value of the rotation Cis in the potential i-th position node Ni when there is applied a considered load condition relating to the load scenarios Ns,
      and also for
c) preferably defining
   a predetermined number of usable sensors N,
   a first binary variable Xi which takes on the value 1 if a sensor is localized in the node corresponding to the first subscript i and 0 if the sensor is not localized, as set out in the formula (1),

$${\sum }_{i ∈ I} Xi = N \qquad ( 1 )$$

a second binary variable Yij which takes on the value 1 if a sensor is localized in the node corresponding to both the first subscript i and the second subscript j and 0 if sensors have not been localized in both nodes i and j (as set out by the formulae (2) and (3)),

$$\begin{matrix}{Y}_{ij} \geq {X}_{i} + {X}_{j} - 1 ∀ i , j ∈ I : i \neq j & ( 2 ) \\ {Y}_{ij} \leq 0.5 ( {X}_{i} + {X}_{j} ) ∀ i , j ∈ I : i \neq j & ( 3 )\end{matrix}$$

a third variable Zi which identifies the distance dij between a node which is identified with the first subscript i and a following node which is adjacent thereto and in which a sensor is positioned (as set out in the formulae (4) and (5)),

$$\begin{matrix}{Z}_{i} \leq {d}_{ij} {Y}_{ij} + d max ( 1 - {Y}_{ij} ) ∀ i , j ∈ I : i \neq j & ( 4 ) \\ {Z}_{i} \geq {d}_{ij} {Y}_{ij} - max dist ( 1 - {W}_{ij} ) ∀ i , j ∈ I : i \neq j & ( 5 )\end{matrix}$$

a fourth binary variable Wij which is used to correlate the third variable Zi with the second variable Yij, and this fourth binary variable Wij takes on a value of 1 only if the following conditions apply (the equations 4 and 5 are still being considered):
   a sensor has been positioned both in the node i and in the node j (or Yij equal to 1),
   j is the node closest to i for which Yij is equal to 1 (or the node j closest to i, between the ones in which a sensor is positioned),
for each node i via the equation (6) set out below, it is imposed that the total at j of the fourth binary variables Wij is equal to 1, or that only one of the above-mentioned variables is equal to 1, being binary, ensuring that this happens for the node j closest to the node i, between the ones in which the sensor is positioned (as also set out by the equation (5)),

$${\sum }_{{j ∈ i}_{i \vert \neq j}} {W}_{ij} = 1 ∀ i ∈ I \qquad ( 6 )$$

a sum function U which represents the total of rotations read by the usable sensors N, the result of which is a vector which represents the sequence of the values assumed by the first binary variable Xi multiplied by the rotation Cis (as shown in the following formula (10)),

$$U = {\sum }_{i = 1}^{Ni} {\sum }_{s = 1}^{{N}_{s}} {C}_{is} {X}_{i} \qquad ( 10 )$$

Preferably, at this point the surveying method and the process to which the present invention relates provide for:
d) imposing the following constraints:
   the effective number of sensors N_{eff} in use is less than or equal to the predetermined number N,
   the number of sensors positioned in each element has to be greater than or equal to the minimum number of sensors defined for this type of element, Eminₜ₍ₑ₎, as set out in the following formula (7):

$${\sum }_{{i ∈ I}_{ielementto ( i ) = e}} {X}_{i} \geq E {min}_{t ( e )} ∀ e ∈ E \qquad ( 7 )$$

the distance dij between a sensor which is arranged in the potential i-th position Ni and another first adjacent sensor which is arranged in the potential j-th position Nj has to be between a minimum distance dₘᵢₙ and a maximum distance dₘₐₓ, where these limitations are imposed on the basis of the type of element to which the node belongs (as set out by the formulae (8) and (9)):

$$\begin{matrix}\begin{matrix}{Z}_{i} \geq d min & ∀ i ∈ I\end{matrix} & ( 8 ) \\ \begin{matrix}{Z}_{i} \leq d max & ∀ i ∈ I\end{matrix} & ( 9 )\end{matrix}$$

e) Using an exact algorithm of the branch and bound or genetic or neural type or combinations thereof in order to calculate a solution Sᵢ which identifies a second plurality of N nodes at which to position at least one sensor and which maximizes the sum function U (as set out in the formula 10), the total of the rotations read by means of the second plurality of N nodes on all the load cases Ns considered (as set out by the formula 11):

$$\begin{matrix}U = {\sum }_{i = 1}^{Ni} {\sum }_{s = 1}^{{N}_{s}} {C}_{is} {X}_{i} & ( 10 ) \\ Maximize U = {\sum }_{i = 1}^{Ni} {\sum }_{s = 1}^{{N}_{s}} {C}_{is} {X}_{i} & ( 11 )\end{matrix}$$

f) Positioning the sensors 3 on the structure 1 in accordance with the solution Sᵢ which is produced by the step e).

In greater detail, the solution Sᵢ corresponds to the maximization of the objective function U as described above in the equation (11) and set out again here.

$$Maximize U = {\sum }_{i = 1}^{Ni} {\sum }_{s = 1}^{{N}_{s}} {C}_{is} {X}_{i} \qquad ( 11 )$$

According to an embodiment, the constraint expressed in the equation (2) imposes the condition that, if a sensor is localized both in the node i and in the node j, then the variable Yij which represents the information that a sensor has been localized in both the nodes, it is forced to assume a value equal to 1.

The constraint expressed in the equation (3) implies that the variable Yij assumes a value 0 if sensors have not been localized in both the nodes i and j. Therefore, the combination of (2) and (3) implies that Yij is equal to 1 if and only if sensors have been localized in both the nodes i and j.

The combination of the constraints as expressed by the equations (4) and (5) allows identification of the minimum distance between the node i and the closest node (excluding itself), in which a sensor is localized.

In greater detail, the constraint (4) imposes a condition that the minimum distance Zi is less than or equal to the distance between the node i and all the other sensors while the constraint (5) implies that Zi is greater than or equal to exactly one of these distances, which logically implies that it is greater than or equal to exactly the smallest one of them, but furthermore the constraint (4) imposes the condition that Zi is less than or equal to all the distances, including the smallest one, then the combination of (4) and (5) necessarily implies that Zi is equal to the smallest one of them.

Preferably, the term maxdist is provided as input data and indicates the greatest distance between two nodes of the set T.

Advantageously, the constraint (6) in combination with the constraint (5) serves to connect the variables W to all the variables Zi.

According to an embodiment, the constraint (7) imposes the condition that for each element the number of localized sensors

N is greater than or equal to the minimum number of sensors required for each predetermined element of this type. Preferably, the constraint (8) implies that the distance between two sensors is greater than dmin while the constraint (9) ensures that each sensor is not more than dmax from the sensor closest to it.

In this context, the terms “optimum method” is intended to be understood to be a method which is capable of providing the best arrangement of a limited number of sensors which can be used.

This technical solution is particularly advantageous considering that the sensors and the installation thereof have a significant cost and that, therefore, the lower the cost associated therewith, the greater is the saving for the company or the user which/who desires to carry out the instrumentation of the structure of interest.

Furthermore, even if there were a very high number of sensors, it is not completely ensured that the arrangement thereof is carried out in accordance with an optimum manner, that is to say, so as to allow better reading in rotation, which is possible with the predetermined number of sensors, so as to reconstitute with a good approximation the current deformation state. As a result of this invention, it is also possible to comply with this requirement.

According to an embodiment of the surveying method, this sensor 3 is a biaxial accelerometer and/or triaxial accelerometer (3a) and/or an inclinometer (3b). In other words, according to an embodiment of the above-mentioned method there is provision for using a device which is capable of providing readings of rotations.

According to an embodiment, the above-mentioned surveying method comprises:
g) using a structural model FEM for identifying the distribution of rotations (Cis) of the structure 1 for each load case Ns in order to calculate the solution Si, which identifies the second plurality of nodes at which to position at least the sensor 3.

It is advantageous to note that, in practice, the modelling allows a change from the physical analysis system to a mathematical model by means of discretizing the system (structural element or overall structure) into monodimensional elements (nodes), bidimensional elements (beam type elements) and/or tridimensional elements (mesh).

This discretization is intended to obtain a discrete model which is characterized by a finite number of degrees of freedom (unlike the real physical system which has an infinite number of degrees of freedom).

Once the structure has been discretized, there are suitably assigned to each element (bidimensional element or tridimensional element) the respective physical, dimensional and mechanical characteristics in order to correctly simulate the behaviour of the real system.

Finally, the system is conditioned or the constraint conditions are introduced in order to simulate the real conditions.

In this context, therefore, a constraint is understood to be any condition which limits the movement of a body.

Finally, there are preferably introduced the load scenarios (point-like forces/linear distributions of forces/pressures (that is to say, forces on surfaces) with which the solving person calculates the rotations in each node of the modelled structure.

This step is advantageously useful in order to define the distribution of rotations Cis which is used in the method carried out according to the present invention.

According to an embodiment, the method used is of the branch and bound type and is a universal method for solving problems of combinatorial optimization (with binary variables) with constraints and linear objective functions, on the basis of the concept of implicit enumeration, or which finds the optimum for a problem by considering all the solutions, which are defined as possible combinations of values taken on by the variables, without enumerating them all explicitly but using criteria of pruning the research tree which allow a priori the exclusion of some families of solutions by identifying them as being sub-optimal.

This method preferably starts with the solution involving the linear relaxation of the problem, obtained by considering variables which belong to the set [0,1] and set {0,1} or variables which can take on any value between 0 and 1.

Preferably, the surveying method provides that
if, during an identification step for the optimum solution to the relaxed problem, all the variables take on whole values 0 or 1, then for the optimum solution to the relaxed problem is also optimum for the original problem, alternatively
continuing with a branching step or selecting one of the variables which takes on a fractional value (x_f) and two nodes are preferably generated in a research tree, by imposing
x_f=0 in the first node and
x_f=1 in the second node,
then continuing to explore new nodes which are iteratively open until there are no other nodes to be analyzed,
defining a node as being “closed”, that is to say, preventing any child node thereof from being generated if any of the following conditions is produced:
1) entirety of the solution,
2) inability to be improved,
3) inadmissibility.

Preferably, the criterion described above in point 1) is verified when the optimum solution to the relaxed problem is complete at a node.

The criterion described above in point 2) is verified when the solution to the relaxed problem in a node is worse than the best solution obtained until now in the exploration of the tree. This implies that no other child node of this node could produce an optimum solution.

Furthermore, the criterion described above in point 3) is verified when the relaxed problem in a node does not allow any permissible solution.

It is thereby possible to optimize the analysis of the nodes which comply with the conditions for being able to produce a “child” and only them.

According to an embodiment, the tolerance value preferably used to define a whole variable is 10⁻⁶.

Advantageously, a user can define a different tolerance value which is defined according to specific requirements.

According to an embodiment which is included in this invention, there is described a process for defining an optimum method of surveying a structure 1, preferably bridges, viaducts or buildings, comprising
defining by means of a structural model FEM a distribution of rotations Cis of the structure 1,
using the distribution of rotations Cis for the whole of the surveying method discussed above in order to calculate the solution Sᵢ which identifies the second plurality of N nodes, given a number N of usable sensors, at which to position at least one sensor and which advantageously maximizes the total of the rotations read by means of the second plurality of N nodes on all the considered load cases Ns.

According to an embodiment, the sensors 3 are positioned on the structure 1 according to the solution Sᵢ which is produced by the step e) of the above-mentioned method.

Furthermore, the method is preferably carried out by surveying the structure 1 under investigation by measuring the conditions of potential anomaly in which the rotations differ from the standard trend which is recorded during the surveying period and exceed one or more predetermined threshold values.

Preferably, the surveying step is carried out in a continuous manner, thereby allowing an ability to measure any potentially anomalous variation of the structure 1 under investigation and an ability to intervene in good time.

It is thereby capable of monitoring the structure being examined and intervening effectively if potentially anomalous conditions were to be found.

1. A method for surveying a structure (1) comprising:
a) defining the following parameters of the structure (1),
a first plurality of elements (2) which constitute the structure (1), in which each element (E) of the first plurality of elements is discretized into a local plurality of corresponding nodes, bidimensional and/or tridimensional elements,
a minimum number of sensors (Eminₜ) for each element (E) which have to be localized in accordance with the type of the element,
a number of nodes (M) in which at least one sensor can be positioned,
a potential i-th position (Ni), having respective coordinates (xi, yi, zi), of the relevant corresponding node on which it is possible to position a sensor (3), the i-th index (i) being an integer between 1 and M,
a potential j-th position (Nj), having respective coordinates (xj, yj, zj), of the relevant corresponding node on which it is possible to position a sensor (3), the j-th index (j) being an integer between 1 and M and different from the value of the i-th index (i),
a matrix of the distances (dij) as a function of each potential i-th position (Ni) and of the potential j-th position (Nj) between the possible nodes (M),
a set (S) of the load scenarios which are applicable to the structure being examined and a corresponding number of the load scenarios (Ns),
a rotation value (Cis) for a potential i-th position node (Ni) which has as a subscript the i-th index (i) and an s-th index (s) between 1 and the number of load scenarios (Ns),
b) defining for each node
a type or class of element to which it belongs,
a specific element of the class (E),
a value of the rotation (Cis) in the potential i-th position node (Ni) when there is applied a considered load condition relating to the load scenarios (Ns),
c) defining
a predetermined number of usable sensors (N),
a first binary variable (Xi) which takes on the value 1 if a sensor is localized in the node corresponding to the i-th index (i) and 0 if the sensor is not localized, as set out in the following formula 1:
$${\sum }_{i ∈ I} Xi = N \qquad ( 1 )$$
a second binary variable (Yij) which takes on the value 1 if a sensor is localized in the node corresponding to both the first subscript of the i-th index (i) and the second subscript the j-th index (j) and 0 if sensors have not been localized in both nodes having the i-th index i and the j-th index j, as set out by the following formulae (2) and (3):
$$\begin{matrix}{Y}_{ij} \geq {X}_{i} + {X}_{j} - 1 ∀ i , j ∈ I : i \neq j & ( 2 ) \\ {Y}_{ij} \leq 0.5 ( {X}_{i} + {X}_{j} ) ∀ i , j ∈ I : i \neq j & ( 3 )\end{matrix}$$
a third variable (Zi) which identifies the distance (dij) between a node which is identified with the first subscript having the i-th index (i) and a following node which is adjacent thereto and in which a sensor is positioned, as set out in the following formulae (4) and (5):
$$\begin{matrix}{Z}_{i} \leq {d}_{ij} {Y}_{ij} + d max ( 1 - {Y}_{ij} ) ∀ i , j ∈ I : i \neq j & ( 4 ) \\ {Z}_{i} \geq {d}_{ij} {Y}_{ij} - max dist ( 1 - {W}_{ij} ) ∀ i , j ∈ I : i \neq j & ( 5 )\end{matrix}$$
a fourth binary variable (Wij) which is used to correlate the third variable (Zi) with the second variable (Yij), and said fourth binary variable (Wij) taking on a value of 1 only if the following conditions apply, the equations (4) and (5) are still being considered:
a sensor has been positioned both in the node having the i-th index (i) and in the node having the j-th index (j) (or the second variable (Yij) is equal to 1,
j-th index (j) is the node closest to the i-th index (i) for which the second variable (Yij) is equal to 1 or the node having the j-th index (j) closest to the i-th index (i), between which a sensor is positioned,
for each node having the i-th index (i) via the equation (6) set out below, it is imposed that the total at the j-th index (j) of the fourth binary variables (Wij) is equal to 1, meaning that only one of the above-mentioned variables is equal to 1, being binary, ensuring that this happens for the node having the j-th index (j) closest to the node having the i-th index (i), between the nodes in which the sensor is positioned, as also set out by the following equation (5),
$${\sum }_{{j ∈ i}_{i \vert \neq j}} {W}_{ij} = 1 ∀ i ∈ I \qquad ( 6 )$$
a sum function (U) which represents the total of rotations read by the usable sensors (N), the result of which is a vector which represents the sequence of the values assumed by the first binary variable (Xi) multiplied by the rotation (Cis), as shown in the following formula (10),
$$U = {\sum }_{i = 1}^{Ni} {\sum }_{s = 1}^{{N}_{s}} {C}_{is} {X}_{i} \qquad ( 10 )$$
d) imposing the following constraints:
the effective number of sensors (N_{eff}) in use is less than or equal to the predetermined number (N),
the number of sensors positioned in each element has to be greater than or equal to the minimum number of sensors defined for this type of element, Eminₜ₍ₑ₎, as set out in the following formula (7):
$${\sum }_{{i ∈ I}_{ielementto ( i ) = e}} {X}_{i} \geq E {min}_{t ( e )} ∀ e ∈ E \qquad ( 7 )$$
the distance (dij) between a sensor which is arranged in the potential i-th position (Ni) and another first adjacent sensor which is arranged in the potential j-th position (Nj) has to be between a minimum distance (dₘᵢₙ) and a maximum distance (dₘₐₓ), where these limitations are imposed on the basis of the type of element to which the node belongs, as set out by the formulae (8) and (9):
$$\begin{matrix}{Z}_{i} \geq d min ∀ i ∈ I & ( 8 ) \\ {Z}_{i} \leq d max ∀ i ∈ I & ( 9 )\end{matrix}$$
e) using an exact algorithm of the branch and bound or genetic or neural type or combinations thereof in order to calculate a solution (Sᵢ)
which identifies a second plurality of (N) nodes at which to position at least one sensor,
which identifies a production of the set of first binary variables (Xi) to which the maximum value of the sum function (U) corresponds, as set out in the following formula (10), that is to say, maximizing the sum function (U) as set out in the following formula (11):
$$\begin{matrix}U = {\sum }_{i = 1}^{Ni} {\sum }_{s = 1}^{{N}_{s}} {C}_{is} {X}_{i} & ( 10 ) \\ Maximum U = {\sum }_{i = 1}^{Ni} {\sum }_{s = 1}^{{N}_{s}} {C}_{is} X & ( 11 )\end{matrix}$$
f) positioning the sensors (3) on the structure (1) in accordance with the solution (Si) which is produced by step e).

2. The method according to claim 1, wherein
the sensor (3) is at least one of: a biaxial accelerometer, a triaxial accelerometer (3a) or an inclinometer (3b).

3. The method according to claim 1, further comprising:
g) using a structural model FEM for identifying the distribution of rotations (Cis) of the structure (1) for each load case (Ns) in order to calculate the solution (Si), which identifies the second plurality of (N) nodes at which to position at least the sensor (3).

4. The method according to claim 1, wherein the algorithm used is a branch and bound type and is a universal method for solving problems of combinatorial optimization, with binary variables, with constraints and linear objective functions on the basis of the concept of implicit enumeration, which is a method capable of finding the optimum for a problem by considering all the solutions, which are defined as possible combinations of values taken on by the variables, without enumerating all of the values explicitly but using criteria of pruning the research tree which allow a priori exclusion of some families of solutions by identifying them as being sub-optimal.

5. The method according to claim 4, wherein the exact branch and bound algorithm starts with a solution involving the linear relaxation of a problem, obtained by considering variables which belong to a set [0,1] or a set {0,1} which are variables which that can take on any value between 0 and 1.

6. The method according to claim 5, wherein
if, during an identification step for the optimum solution to the relaxed problem, all the variables take on whole values 0 or 1, then the optimum solution to the relaxed problem is also optimum for the original problem, alternatively
continuing with a branching step, that is to say selecting one of the variables which takes on a fractional value (x_f) and two nodes are prferably generated in a research tree, by imposing
x_f=0 in the first node and
x_f=1 in the second node,
then continuing to explore new nodes which are iteratively open until there are no other nodes to be analyzed,
defining a node as being “closed”, preventing any child node thereof from being generated if any of the following conditions is produced:
1) entirety of the solution,
2) inability to be improved, or
3) inadmissibility.

7. The method according to claim 6, wherein the tolerance value used to define a whole variable is 10⁻⁶.

8. A process for defining an optimum method of surveying a structure (1), the method comprising
calculating by means of a structural model FEM (finite element method) a distribution of rotations (Cis) of nodes in which the structure (1) is discretized, some or all of the nodes of the structural model FEM may be potential candidates for the positioning of a sensor,
using the distribution of rotations (Cis) for the whole of a method according to claim 1 or dependent claims in order to calculate a solution (Sᵢ) which identifies a plurality of a defined number of nodes (N) at which to position at least one sensor and which maximizes the total of the rotations read by means of the plurality of N nodes on all the considered load cases (Ns), and positioning the sensors (3) on the structure (1) according to the solution (Si) which is produced by step e) of the method,
surveying the structure (1) under investigation by measuring the conditions of potential anomaly in which the rotations differ from the standard trend which is recorded during the surveying period and exceed one or more predetermined threshold values.

9. The process according to claim 8, wherein the surveying step is carried out in a continuous manner over time, thereby allowing measurability of any potentially anomalous variation of the structure (1) under investigation and an ability to intervene in good time.
